(19) United States
(12) Patent Application Publication
(10) Pub. No.: US 2009/0271833 A1
(43) Pub. Date: Oct. 29, 2009

(54) METHOD AND APPARATUS WITH SUBSCRIPTION QUALITY OF SERVICE IN A VIDEO SYSTEM

(75) Inventors: Indra Laksono, Richmond Hill (CA); Paul Ducharme, Scarborough (CA)

Correspondence Address: GARLICK HARRISON & MARKISON, P.O. BOX 160727, AUSTIN, TX, 78716-0727, US

(73) Assignee: VIXS SYSTEMS, INC., Toronto (CA)

(21) Appl. No.: 12/497,897

(22) Filed: Jul. 6, 2009

Related U.S. Application Data
(62) Division of application No. 09/946,919, filed on Sep. 5, 2001.

(51) Int. Cl. H04N 7/173; H04N 11/20

(52) U.S. Cl. 725/100; 348/445; 348/E11.021

(57) ABSTRACT

A method and apparatus for controlling access to a video system based on bandwidth consumption include processing that begins as the server monitors bandwidth utilization of connections within the video system. The processing continues when the server receives a request to access a video program via the connection from a client device of the video system. The processing then continues as the server determines whether determine whether the client device has subscribed to receive the video program at the first quality level. When the client device has not subscribed to receive the video program at the first quality level, the video quality of the video program is converted from the first quality level to a video quality subscribed to by the client device.

### CROSS REFERENCE TO RELATED APPLICATIONS

The present application is a divisional of copending U.S. patent application having Ser. No. 09/946,919, filed on Sep. 5, 2001, entitled, METHOD AND APPARATUS FOR PAY-PER-QUALITY OF SERVICE FOR BANDWIDTH CONSUMPTION IN A VIDEO SYSTEM.

### TECHNICAL FIELD OF THE INVENTION

The present invention relates generally to video systems and more particularly to controlling access to such systems based on bandwidth availability.

### BACKGROUND OF THE INVENTION

As is known, video on demand systems include a plurality of redundant array of independent disks (RAID), a server, quadrature amplitude modulation (QAM) modules and a plurality of clients. The clients are operably coupled to the server via a cable network and at least one of the QAM modules. The server is operably coupled to each of the RAIDs via a fixed bandwidth connection, such as an a small computer system interface (SCSI) or an integrated drive electronics (IDE) interface, which allows data to be retrieved at rates of 14 to 30 megabytes per second. The server is also operably coupled to each of the QAM modules via another fixed bandwidth connection, such as an alternate space inversion (ASI) connection, which basically includes modulated fixed bit rate binary streams containing MPEG transport streams. Such ASI interfaces may operate at rates up to 240 megabits per second in a point-to-point connection.

Each of the RAIDs stores is known to comprise a large disk storage system that provides vast amounts of data storage for storing video and audio programs in digital form. The server may access any of the programs stored by any of the RAIDs via the associated fixed bandwidth connection in response to a client request. Before the server can access a program, it must first determine that the system has sufficient bandwidth to support the client request. If the system does not have sufficient bandwidth of the interfaces between the server and the RAID, between the server and the QAM module supporting the client, or between a QAM module and the cable network, then the client's request is denied.

Since the bandwidth between the server and the RAIDs and the bandwidth between the server and QAM modules are fixed, the system can only support a limited number of clients. For example, if the bandwidth of a connection between a QAM module and the cable network is 38.5 Mbps (megabits per second) and each program requires 3 Mbps, then only twelve clients may be supported at any given time by the QAM module. Accordingly, any additional requests that must be supported by the QAM module will be denied.

As is also known, client access to a video on demand system is not uniformed throughout a day or throughout a week. For example, weekday evenings typically have a higher client user rate than during weekday mornings or afternoon or during late nights. As such, there is a greater likelihood that a video on demand system will become congested, thus not being able to service all requesting clients, during such high use times. Yet, regardless of the time a video on demand system is accessed or the congestion of the system, the cost for a program is fixed.

As is known, charging variable rates for accessing a system based on the time of day or the day of week is not new. For example, cellular telephone systems charge users varying rates depending on when the user accesses the cellular system. However, such variable rates are based on the day of the week and/or the time of the day, not based on current congestion of the system.

Therefore, a need exists for a method and apparatus for varying the rates and/or quality of service of a video system based on congestion of the system.

### BRIEF DESCRIPTION OF THE DRAWINGS

FIG. 1 illustrates a schematic block diagram of a video system in accordance with the present invention;

FIG. 2 illustrates a logic diagram of a method for controlling access to a video system in accordance with the present invention;

FIG. 3 illustrates a logic diagram of method that further describes the determination of exceeding bandwidth threshold of FIG. 2;

FIG. 4 illustrates a logic diagram of an alternate method that further describes the determination of exceeding bandwidth threshold of FIG. 2;

FIG. 5 illustrates a logic diagram of an alternate method for controlling access to a video system in accordance with the present invention; and

FIG. 6 illustrates a logic diagram of yet another alternate method for controlling access to a video system in accordance with the present invention.

### DETAILED DESCRIPTION OF A PREFERRED EMBODIMENT

Generally, the present invention provides a method and apparatus for controlling access to a video system based on bandwidth consumption. Such a method and apparatus include processing that begins as the server monitors bandwidth utilization of connections within the video system. The processing continues when the server receives a request to access a video program via the connection from a client device of the video system. The processing then continues as the server determines whether the bandwidth utilization exceeds a bandwidth threshold. If the bandwidth utilization exceeds the bandwidth threshold, the server provides an indication of viewing-cost options (e.g., pay a premium and receive the program now, wait until the bandwidth utilization of the system is reduced and pay a nominal fee, etc.) regarding access to the video program to the client device. The processing then continues as the client selects one of the viewing-cost options and provides the selected option to the server. The processing then continues as the server processes the request to access the video program based on the response. With such a method and apparatus, access to the video system is controlled based on bandwidth utilization and service fees may be varied based on such bandwidth utilization.

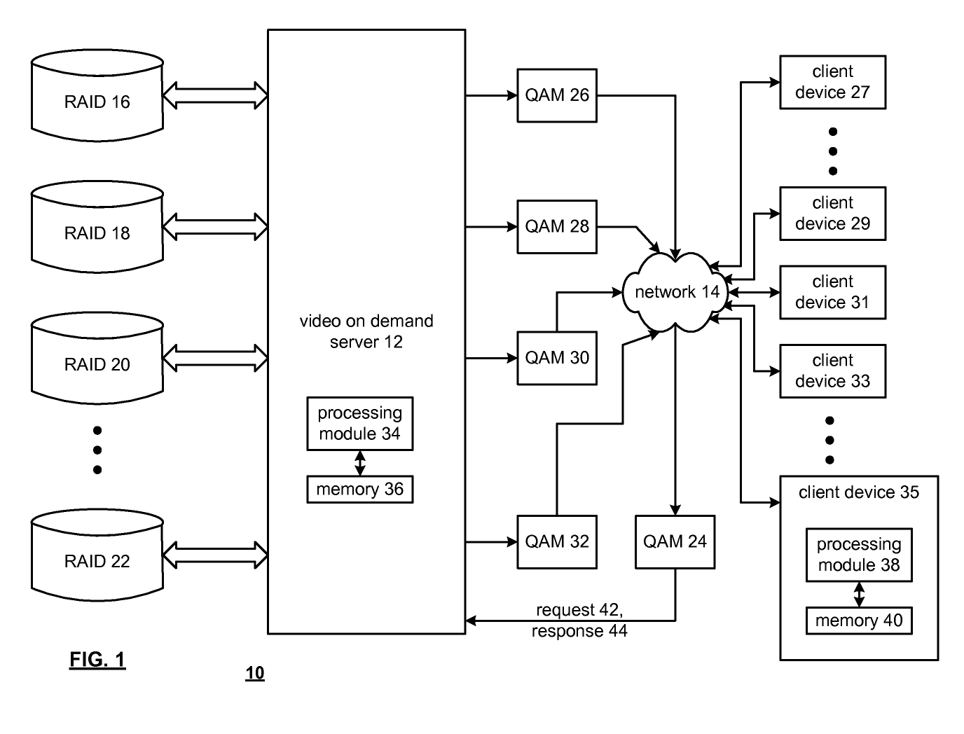

The present invention may be further described with reference to FIGS. 1-6. FIG. 1 illustrates a schematic block diagram of a video system 10 that includes a video on demand server 12, a network 14, a plurality of RAIDs 16, 18, 20 and 22, a plurality of QAM modules 24, 26, 28, 30 and 32, and a plurality of client devices 27, 29, 31, 33 and 35. The network 14 may be a cable network, the Internet, public switched telephone network, and/or any other type of network that supports packets of audio and/or video data.

The server 12 includes a processing module 44 and memory 46. Each of the clients includes a processing module 48 and memory 50. The processing module 44 and processing module 48 each may be a single processing device or a plurality of processing devices. Such a processing device may be a microprocessor, microcomputer, digital signal processor, central processing unit, programmable gate array, programmable logic device, state machine, logic circuitry, and/or any device that manipulates signals (analog and/or digital) based on operational instructions. The memory 46 or 50 may be a single memory device or a plurality of memory devices. Such a memory device may be a volatile memory device, non-volatile memory device, static memory device, dynamic memory device, read-only memory, random access memory, magnetic tape memory, flash memory, and/or any device that stores digital information. The operational instructions stored in memory 46 or 50 and executed by processing module 44 and 48 will be described below with reference to one or more of FIGS. 2-6.

In operation, a client device, such as any one of client devices 27, 29, 31, 33 and 35, which may be a set top box, multimedia system, satellite receiver, etc., provides a request 52 for accessing a video program to the server 12. The request 52 identifies the particular video program being requested, the identity of the client, and/or any other information necessary to identify the request and provide the appropriate video program to the requesting client. Upon receiving the request, the server 12 determines which RAID 16, 18, 20 and 22 stores the requested video program and which QAM will support the conveyance of the video program to the client. In addition, the server determines the bandwidth utilization between the server and the RAID storing the video program, between the server and the QAM module, and the QAM module and the network 14.

The server 12 then determines whether the bandwidth utilization exceeds a threshold. If the current utilization of the communication paths between the RAID and the client is below the threshold, the server provides the video program to the user via the communication paths. If, however, the bandwidth utilization of one of the communication paths exceeds the threshold, the server 12 provides cost-viewing options to the client. The client then generates a response 54 from the cost-viewing options and provides the response to the server 12. The server 12 provides the video program to the client in accordance with the response 54. The details of providing video programs to the clients as generally described with reference to FIG. 1 is described in greater detail in FIGS. 2-6.

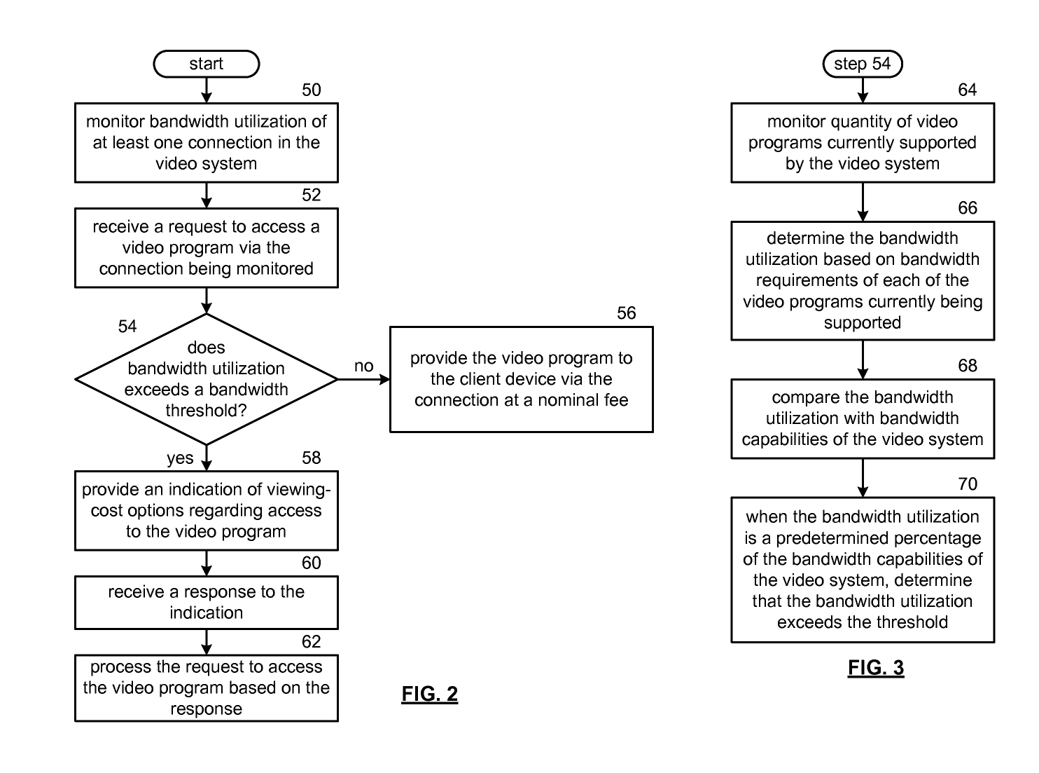

FIG. 2 illustrates a logic diagram of method for pay-per-quality of service based on bandwidth consumption. The processing begins at step 50 where a video on demand server monitors bandwidth utilization of at least one connection in the video system. In one embodiment, the server monitors the bandwidth utilization of each communication into and out of the server, the RAIDs, and the QAM modules. The determination of bandwidth utilization will be discussed in greater detail with reference to FIG. 3.

The processing then proceeds to step 52 where the server receives a request to access a video program via the at least one connection from a client device. The request identifies the video program, the client device, and any other information necessary for processing the video request. The processing then continues to step 54, where the server determines whether the bandwidth utilization of the connection exceeds a bandwidth threshold. The bandwidth threshold may vary depending on the bit rate of the video programs being supported and the bandwidth limitations of the connection. As such, the threshold may be based on the number of video programs currently supported by the connection, a predetermined ratio of the bandwidth utilization to the total bandwidth of the connection, etc. If the bandwidth utilization does not exceed the threshold, the server provides the video program to the user at a nominal rate without restriction.

If the bandwidth utilization exceeds the bandwidth threshold, the process proceeds to step 58 where the server provides an indication of viewing-cost options regarding access to the video program to the client device. The viewing-cost options include, but are not limited to, access the video program now at an increased fee, access the video program when the bandwidth utilization drops below the bandwidth threshold at a nominal fee, access the video program at a lower video quality now at an alternate increased fee, and access the video program now at the nominal fee but the accessing is preemptable when the bandwidth utilization exceeds a second threshold.

The process then proceeds to step 60, where the server receives a response to the indication from the client device. The response will be the selection of one of the viewing-cost options. The processing then proceeds to step 62 where the server processes the request for access to the video program in accordance with the selected viewing-cost option.

FIG. 3 illustrates a logic diagram of method for determining bandwidth utilization and whether the threshold is exceeded. The processing begins at step 64 where the server monitors the quantity of video programs currently being supported by the connection of the video system that will need to support the requested video program. The process then proceeds to step 66 where the server determines the bandwidth utilization of the connection based on bandwidth requirements of each video program currently being supported. As previously mentioned, the connections within the video system are of a fixed bandwidth. As also mentioned, each video program has a certain bandwidth requirement. Thus, based on a linear function, one can readily determine the current bandwidth utilization and the number of video programs that can be further supported by the connection.

The process then proceeds to step 68 where the server compares the bandwidth utilization with the bandwidth capabilities of the connection of the video system. The process then proceeds to step 70 where the server determines whether the bandwidth utilization is a predetermined percentage of the bandwidth capabilities of the connection of the video system. If the bandwidth utilization exceeds the percentage, the server indicates that the bandwidth utilization exceeds the threshold. For example, assume the connection has a bandwidth of 38.5 Mbps and each video program has a bandwidth requirement of 3 Mbps. The connection is currently supporting 7 video programs, thus 21 Mbps of its 38.5 Mbps of bandwidth is used. If the threshold was set at 8 video programs, reserving the last 4 video programs to be supported by the connection to be charged a premium, the threshold is not exceeded. Thus, the present video program request would be processed without viewing-cost restriction. For the next video program, the request is exceeded, such that the viewing-cost options will be provided the client.

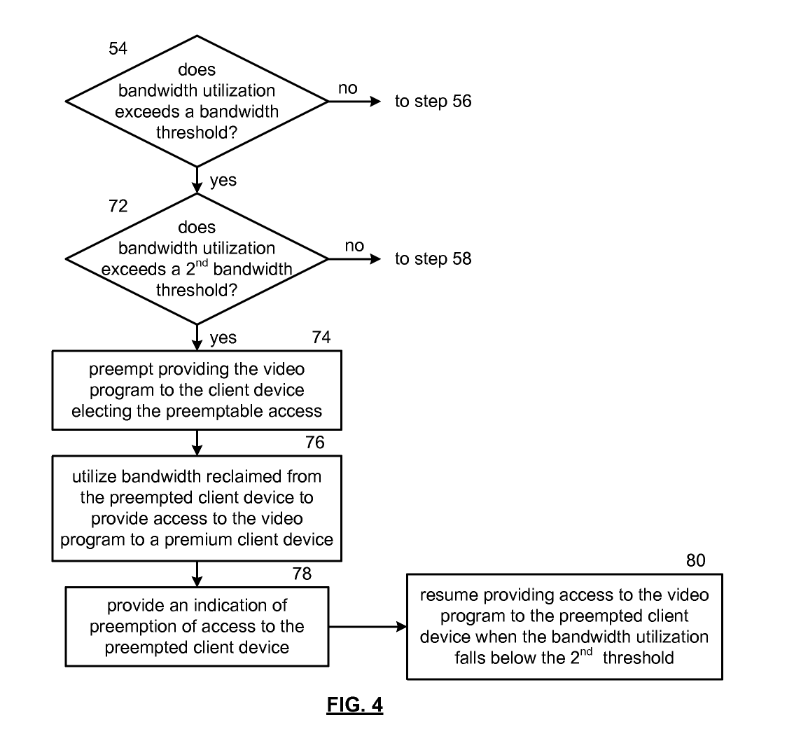

FIG. 4 illustrates a logic diagram that further describes the processing of whether the threshold has been exceeded by the bandwidth utilization. The processing begins at step 54 where the server determines whether the threshold is exceeded. If not, the process reverts to step 56 of FIG. 2. If the threshold is exceeded, the process then proceeds to step 72 where the server determines when a second threshold is exceeded. If not, the process proceeds to step 58 of FIG. 2.

If the bandwidth utilization exceeds the second threshold, the process proceeds to step 74 where the server preempts providing the video program to a client that elected the preemptable access to the video program. The process then proceeds to step 76 where the server utilizes the bandwidth reclaimed from the client in step 74 to provide access to the video program to a client device electing accessing the video program now at the increased fee. The process then proceeds to step 78 where the server provides an indication of preemption of access to the client device of step 74. The process then proceeds to step 80 where the server resumes providing access to the video program to the client device of step 74 when the bandwidth utilization falls below the second threshold.

FIG. 5 illustrates a logic diagram of method for a client device within a video system to process pay-per-quality of service. The processing begins at step 90 where the client device receives a video program having a first quality level. The first quality level may be one of high definition television, motion joint photographic expert group (MJPEG), motion picture expert group (MPEG) N, where N corresponds to a version of MPEG standard, standard digital television, consumer digital video, or ITU-T H.263. The processing then continues to step 92 where the client device determines whether it has subscribed to receive the video program at the first quality level. If so, the process proceeds to step 94 where the client device presents the video program at the first quality level.

If the client device has not subscribed to receive the video program at the first quality level, the process proceeds to step 96 where the client device converts the video quality of the video program from the first quality level to a video quality subscribed to by the client device. The second video quality is a level of video quality below the first video quality and may be one of high definition television, motion joint photographic expert group (MJPEG), motion picture expert group (MPEG) N, where N corresponds to a version of MPEG standard, standard digital television, consumer digital video, ITU-T H.263, or ITU-T H.261.

In general, the second quality level is below the first video quality. For example, if the first video quality level is HDTV, the second video quality level may be SDTV. By having the client devices process the quality conversion, the server only has to provide one quality level of a video program as opposed to multiple versions, thus saving bandwidth of the server.

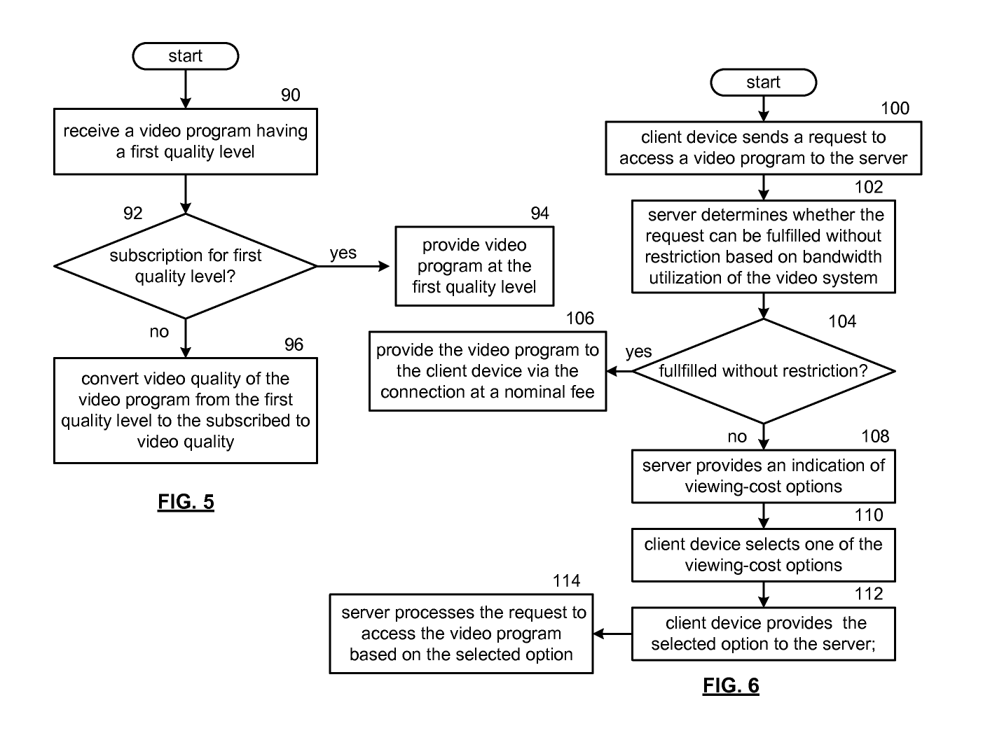

FIG. 6 illustrates a logic diagram of method for pay-per-quality of service for bandwidth consumption in a video system. The processing begins at step 100 where the client device sends a request to access a video program to server of the video system. The process then proceeds to step 102 where the server determines whether the request can be fulfilled without restriction based on bandwidth utilization of the video system. If the request can be fulfilled without restriction, the process proceeds to step 106 where the server provides the video program to the client device via a connection at a nominal fee.

If, however, at step 104 it was determined that the request cannot be fulfilled, the process proceeds to step 108. At step 108 the server provides an indication of viewing-cost options regarding access to the video program to the client device. The process then proceeds to step 110 where the client device selects one of the viewing-cost options to produce a selected option. The process then proceeds to step 112 where the client device provides the selected option to the server. The process then proceeds to step 114 where the server processes the request to access the video program based on the selected option.

The preceding discussion has presented a method and apparatus for providing a pay-per-quality of service based on bandwidth utilization of a video system. Based on congestion of the video system, the video system may charge a premium for viewing a video program when the video system is congested. As one of average skill in the art will appreciate, other embodiments may be derived by the teachings of the present inventions without deviated from the scope of the claims.

What is claimed is:

1. A method for a client device within a video system to process pay-per-quality of service, the method comprises:
receiving a video program having a first quality level;
determining whether the client device has subscribed to receive the video program at the first quality level; and
when the client device has not subscribed to receive the video program at the first quality level, converting video quality of the video program from the first quality level to a video quality subscribed to by the client device.

2. The method of claim 1, wherein the first quality level comprises at least one of:
high definition television;
motion joint photographic expert group (MJPEG);
motion picture expert group (MPEG) N, where N corresponds to a version of MPEG standard;
standard digital television;
consumer digital video; and
ITU-T H.263.

3. The method of claim 2, wherein the video quality subscribed to the client device comprises at least one of:
high definition television;
motion joint photographic expert group (MJPEG);
motion picture expert group (MPEG) N, where N corresponds to a version of MPEG standard;
standard digital television;
consumer digital video;
ITU-T H.263; and
ITU-T H.261, wherein processing requirements of the first quality level is greater than processing requirements of the video quality subscribed to by the client device.

4. The method of claim 1, wherein the determining whether the client device has
subscribed to receive the video program at the first quality level further comprises:
determining the quality level subscribed to by the client device;
obtaining an indication of the first quality level;
comparing the quality level subscribed to with the indication of the first quality level; and
when the quality level subscribed to does not substantially match the indication of the first quality level, indicating that the client device has not subscribed to receive the video program at the first quality level.

5. The method of claim 1, wherein the converting the video quality of the video program further comprises:
when the first quality level is high definition television, converting the video program from a high definition television format to a standard definition television format.

6. A method for pay-per-quality of service for bandwidth consumption in a video system, the method comprises:
sending, by a client device of the video system, a request to access a video program to server of the video system;
determining, by the server, whether the request can be fulfilled without restriction based on bandwidth utilization of the video system;
when the request cannot be fulfilled without restriction, providing, by the server, an indication of viewing-cost options regarding access to the video program to the client device;
selecting, by the client device, one of the viewing-cost options to produce a selected option;
providing, by the client device, the selected option to the server; and
processing, by the server, the request to access the video program based on the selected option;
receiving the video program having a first quality level;
determining whether the client device has subscribed to receive the video program at the first quality level; and
when the client device has not subscribed to receive the video program at the first quality level, converting video quality of the video program from the first quality level to a video quality subscribed to by the client device.

7. A client device within a video system comprises:
processing module; and
memory operably coupled to the processing module, wherein the memory includes operational instructions that cause the processing module to:
receive a video program having a first quality level;
determine whether the client device has subscribed to receive the video program at the first quality level; and
when the client device has not subscribed to receive the video program at the first quality level, convert video quality of the video program from the first quality level to a video quality subscribed to by the client device.

8. The client device of claim 7, wherein the first quality level comprises at least one of:
high definition television;
motion joint photographic expert group (MJPEG);
motion picture expert group (MPEG) N, where N corresponds to a version of MPEG standard;
standard digital television;
consumer digital video; and
ITU-T H.263.

9. The client device of claim 8, wherein the video quality subscribed to the client device comprises at least one of:
high definition television;
motion joint photographic expert group (MJPEG);
motion picture expert group (MPEG) N, where N corresponds to a version of MPEG standard;
standard digital television;
consumer digital video;
ITU-T H.263; and
ITU-T H.261, wherein processing requirements of the first quality level is greater than processing requirements of the video quality subscribed to by the client device.

10. The client device of claim 7, wherein the memory further comprises operational instructions that cause the processing module to determine whether the client device has subscribed to receive the video program at the first quality level by:
determining the quality level subscribed to by the client device;
obtaining an indication of the first quality level;
comparing the quality level subscribed to with the indication of the first quality level; and
when the quality level subscribed to does not substantially match the indication of the first quality level, indicating that the client device has not subscribed to receive the video program at the first quality level.

11. The client device of claim 7, wherein the memory further comprises operational instructions that cause the processing module to convert the video quality of the video program by:
when the first quality level is high definition television, converting the video program from a high definition television format to a standard definition television format.

12. An apparatus for pay-per-quality of service for bandwidth consumption in a video system, the apparatus comprises:
processing module; and
memory operably coupled to the processing module, wherein the memory includes operational instructions that cause the processing module to:
send, at a client device of the video system, a request to access a video program to server of the video system;
determine, at the server, whether the request can be fulfilled without restriction based on bandwidth utilization of the video system;
when the request cannot be fulfilled without restriction, provide, as the server, an indication of viewing-cost options regarding access to the video program to the client device;
select, as the client device, one of the viewing-cost options to produce a selected option;
provide, as the client device, the selected option to the server; and
process, as the server, the request to access the video program based on the selected option;
receive the video program having a first quality level;
determine whether the client device has subscribed to receive the video program at the first quality level; and
when the client device has not subscribed to receive the video program at the first quality level, convert video quality of the video program from the first quality level to a video quality subscribed to by the client device.
